(19) United States
(12) Patent Application Publication
(10) Pub. No.: US 2011/0150217 A1
(43) Pub. Date: Jun. 23, 2011

(54) METHOD AND APPARATUS FOR PROVIDING VIDEO CONTENT, AND METHOD AND APPARATUS REPRODUCING VIDEO CONTENT

(75) Inventors: Hee-jean KIM, Yongin-si (KR); Seung-ryong KOOK, Suwon-si (KR)

(73) Assignee: SAMSUNG ELECTRONICS CO., LTD., Suwon-si (KR)

(21) Appl. No.: 12/974,213

(22) Filed: Dec. 21, 2010

(30) Foreign Application Priority Data
Dec. 21, 2009 (KR) 10-2009-0128340

(51) Int. Cl. H04N 7/167; H04L 9/08

(52) U.S. Cl. 380/210

(57) ABSTRACT

A method of providing video content, the method comprising generating a basement layer and a plurality of enhancement layers by performing scalable video coding on a piece of video content; encrypting the basement layer and the plurality of enhancement layers by using different encryption keys, respectively; and transmitting one of the encryption keys to the second device, together with a video content package that comprises the encrypted basement layer and enhancement layers. The encryption keys include a random encryption key generated randomly and chain encryption keys generated sequentially by performing a Hash function on the random encryption key at least one time.

### CROSS-REFERENCE TO RELATED PATENT APPLICATION

This application claims priority from Korean Patent Application No. 10-2009-0128340, filed on Dec. 21, 2009, in the Korean Intellectual Property Office, the disclosure of which is incorporated herein in its entirety by reference.

### BACKGROUND

1. Field

Apparatuses and methods consistent with the exemplary embodiments relate to a method and apparatus for providing video content and a method and apparatus for reproducing video content, and more particularly, to a method and apparatus for providing scalable video coding (SVC)-based video content and a method and apparatus for reproducing SVC-based video content.

2. Description of the Related Art

As content, particularly video content, has become increasingly actively exchanged (transmitted and received), various video coding schemes have been developed in order to effectively transmit and receive the video content. In particular, it is expected that video content, which is coded using a scalable video coding (SVC) method standardized in accordance with H.264 scalable extension, will be used for various purposes in the future.

### SUMMARY OF THE EXEMPLARY EMBODIMENTS

The exemplary embodiments provide a method and apparatus for providing scalable video coding (SVC)-based video content.

The exemplary embodiments also provide a method and apparatus for reproducing SVC-based video content.

According to an aspect of the exemplary embodiments, there is provided a method of providing scalable video coding-based video content from a first device to a second device, the method including generating a basement layer and a plurality of enhancement layers by performing scalable video coding on a piece of video content; encrypting the basement layer and the plurality of enhancement layers by using different encryption keys, respectively; and transmitting one of the encryption keys to the second device, together with a video content package that includes the encrypted basement layer and enhancement layers, wherein the encryption keys include a random encryption key generated randomly; and chain encryption keys generated sequentially by performing a Hash function on the random encryption key at least one time.

During the generating of the basement layer and the plurality of enhancement layers, a lowest resolution layer having a resolution lower than the resolution of the basement layer may be further generated. The video content package may further include the lowest resolution layer.

The plurality of enhancement layers may include a first enhancement layer and a second enhancement layer. The encrypting of the basement layer and the plurality of enhancement layers may include encrypting the second enhancement layer by using the random encryption key; encrypting the first enhancement layer by using a first chain encryption key that is generated by applying the Hash function on the random encryption key; and encrypting the basement layer by using a second chain encryption key that is generated by applying the Hash function on the first chain encryption key.

The method may further include receiving a request for video content having a predetermined resolution from the second device. The transmitting of one of the encryption keys to the second device, together with the video content package, may include transmitting one of the encryption keys, which corresponds to the request, to the second device, together with the video content package.

During the encrypting of the basement layer and the plurality of enhancement layers, the encrypting may be performed according to a symmetric key coding scheme.

According to another aspect of the exemplary embodiments, there is provided a method of reproducing scalable video coding-based video content, the method including receiving a video content package that includes an encrypted basement layer and a plurality of encrypted enhancement layers; receiving a decryption key for decrypting the encrypted basement layer and enhancement layers included in the video content package; decrypting at least one of the encrypted enhancement layers, and the encrypted basement layer by using the decryption key and a Hash function; and reproducing the video content package based on a result of the decrypting.

The decrypting of the at least one of the encrypted enhancement layers and the encrypted basement layer may include generating chain decryption keys sequentially by performing the Hash function on the decryption key at least one time; and decrypting at least one of the encrypted enhancement layers, and the encrypted basement layer by using at least one of the chain decryption keys and the decryption key.

The method may further include checking whether the video content package includes a lowest resolution layer having a resolution lower than the resolution of the basement layer, when the video content package is received; and reproducing the video content package based on the lowest resolution layer, when the video content package includes the lowest resolution layer. The receiving of the decryption key may include receiving the decryption key based on a result of the reproducing.

The encrypted enhancement layers may include an encrypted first enhancement layer and an encrypted second enhancement layer. The decrypting of the at least one of the encrypted enhancement layers and the encrypted basement layer may include decrypting the encrypted second enhancement layer by using the decryption key; decrypting the encrypted first enhancement layer by using a first chain decryption key that is generated by performing the Hash function on the decryption key; and decrypting the encrypted basement layer by using a second chain decryption key that is generated by performing the Hash function on the first chain decryption key.

The method may further include transmitting a request for the video content package and video content having a predetermined resolution to a device that stores the video content package. The receiving of the decryption key may include receiving a decryption key corresponding to the request.

According to another aspect of the exemplary embodiments, there is provided an apparatus for providing scalable video coding-based video content from a first device to a second device, the apparatus including a layer generation unit for generating a basement layer and a plurality of enhancement layers by performing scalable video coding on a piece of video content; an encryption unit for encrypting the basement layer and the plurality of enhancement layers by using different encryption keys, respectively; and a transmission unit for transmitting one of the encryption keys to the second device, together with a video content package that includes the encrypted basement layer and enhancement layers, wherein the encryption keys include a random encryption key generated randomly; and chain encryption keys generated sequentially by performing a Hash function on the random encryption key at least one time.

According to another aspect of the exemplary embodiments, there is provided an apparatus for reproducing scalable video coding-based video content, the method including a receiving unit for receiving a video content package that includes an encrypted basement layer and a plurality of encrypted enhancement layers, and a decryption key for decrypting the encrypted basement layer and enhancement layers included in the video content package; a decryption unit for decrypting at least one of the encrypted enhancement layers, and the encrypted basement layer by using the decryption key and a Hash function; and a reproduction unit for reproducing the video content package based on a result of the decrypting.

According to another aspect of the exemplary embodiments, there is provided a computer readable recording medium having recorded thereon a computer program for executing a method of providing scalable video coding-based video content from a first device to a second device, the method including generating a basement layer and a plurality of enhancement layers by performing scalable video coding on a piece of video content; encrypting the basement layer and the plurality of enhancement layers by using different encryption keys, respectively; and transmitting one of the encryption keys to the second device, together with a video content package that includes the encrypted basement layer and enhancement layers, wherein the encryption keys include a random encryption key generated randomly; and chain encryption keys generated sequentially by performing a Hash function on the random encryption key at least one time.

According to another aspect of the exemplary embodiments, there is provided a computer readable recording medium having recorded thereon a computer program for executing a method of reproducing scalable video coding-based video content, the method including receiving a video content package that includes an encrypted basement layer and a plurality of encrypted enhancement layers; receiving a decryption key for decrypting the encrypted basement layer and enhancement layers included in the video content package; decrypting at least one of the encrypted enhancement layers, and the encrypted basement layer by using the decryption key and a Hash function; and reproducing the video content package based on a result of the decrypting.

### BRIEF DESCRIPTION OF THE DRAWINGS

The above and other aspects of the exemplary embodiments will become more apparent by describing in detail exemplary embodiments thereof with reference to the attached drawings in which:

FIG. 1 is a flowchart illustrating a method of providing scalable video coding (SVC)-based video content according to an exemplary embodiment;

FIG. 2 is a block diagram of a method of providing SVC-based video content according to an exemplary embodiment;

FIG. 3 is a flowchart illustrating a method of providing SVC-based video content according to anther exemplary embodiment;

FIG. 4 is a flowchart illustrating a method of providing SVC-based video content according to anther exemplary embodiment;

FIGS. 5 to 7 are block diagrams of methods of providing SVC-based video content according to exemplary embodiments;

FIG. 8 is a flowchart illustrating a method of reproducing SVC-based video content according to an exemplary embodiment;

FIG. 9 is a block diagram of an apparatus for providing SVC-based video content according to an exemplary embodiment; and

FIG. 10 is a block diagram of an apparatus for reproducing SVC-based video content according to an exemplary embodiment.

### DETAILED DESCRIPTION OF THE EXEMPLARY EMBODIMENTS

Hereinafter, exemplary embodiments will be described in detail with reference to the accompanying drawings.

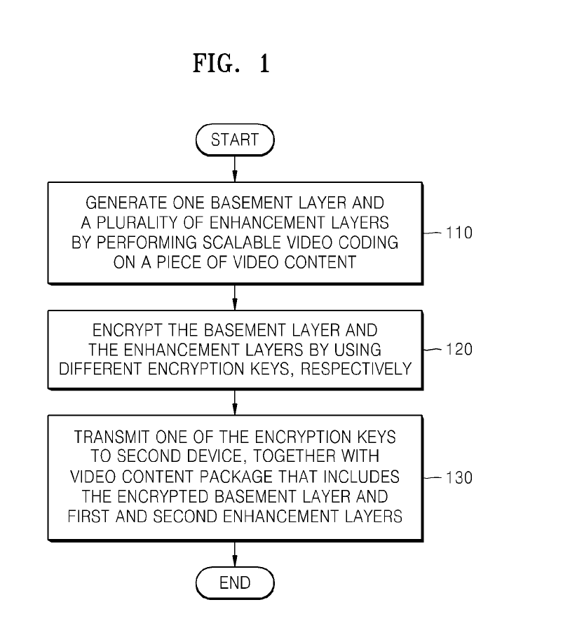

FIG. 1 is a flowchart illustrating a method of providing scalable video coding (SVC)-based video content according to an exemplary embodiment.

Here, it is assumed that operations 110 to 130 are performed by a video content providing apparatus according to an exemplary embodiment, which is included in a first device. The first device includes various types of devices, e.g., a content server, which can store video content, but is not limited thereto.

In operation 110, SVC is performed on a piece of video content to generate one basement layer and a plurality of enhancement layers.

For example, SVC may be performed on a piece of video content to generate one basement layer, a first enhancement layer, and a second enhancement layer. A basement layer and an enhancement layer are obvious to those of ordinary skill in the field of SVC and will not be described here.

In operation 120, the basement layer and the plurality of enhancement layers are encrypted using a plurality of different encryption keys, respectively.

In an exemplary embodiment, the plurality of encryption keys include one random encryption key that is randomly generated and chain encryption keys that are generated sequentially by applying a Hash function to the random encryption key at least one time.

For example, if the random encryption key is generated randomly, a first chain encryption key is generated by applying the Hash function to the random encryption key and a second chain encryption key is generated by applying the Hash function to the first chain encryption key. In this case, the random encryption key may be a random number or may be an encryption key that is randomly extracted from a plurality of encryption keys stored in a database. The Hash function may be a Message-Digest algorithm 5 (MD5), a Secure Hash Algorithm-1 (SHA-1), or a Secure Hash Algorithm-2 (SHA-2).

If the plurality of encryption keys are generated as described above, an encryption process is performed using the plurality of encryption keys. For example, if the basement layer, the first enhancement layer, and the second enhancement layer are generated from the piece of video content, then the second enhancement layer may be encrypted using the random encryption key, the first enhancement layer may be encrypted using the first chain encryption key that has been generated by applying the Hash function to the random encryption key, and the basement layer may be encrypted using the second chain encryption key that has been generated by applying the Hash function to the first chain encryption key. In this case, the basement layer and the first and second enhancement layers are encrypted according to a symmetric key coding scheme in which an encryption key is identical to a decryption key.

In operation 130, one of the plurality of encryption keys is transmitted to a second device, together with a video content package that includes the encrypted basement layer and the enhancement layers.

Here, the encryption keys may be included in a license for the video content package and may be transmitted to the second device together with the license. The second device includes various types of devices, such as portable multimedia players (PMPs), mobile phones, notebooks, that can reproduce video content, but are not limited thereto.

In general, at least one encryption key is transmitted to the second device from among the plurality of encryption keys, based on a desired resolution of video content that a user of the second device wants to view.

For example, if the video content package includes the basement layer encrypted using the first encryption key, the first enhancement layer encrypted using the second encryption key, and the second enhancement layer encrypted using a third encryption key, then the first encryption key is transmitted to the second device when the user of the second device wants to view video content having a normal resolution and the first and second encryption keys are transmitted to the second device when the user of the second device wants to view video content having a high resolution, and the first to third encryption keys are transmitted to the second device when the user of the second device wants to view video content having an ultra high resolution. In this case, the normal resolution may correspond to a quarter video graphics array (QVGA), the high resolution may correspond to a VGA, and the ultra high resolution may correspond to a resolution of 720 p (progressive scanning) As described above, the higher the resolution of content that the user of the second device wants to view, the more encryption keys have to be transmitted to the second device.

However, in an exemplary embodiment, only one encryption key, corresponding to a resolution of video content that the user of the second device wants to view, is transmitted to the second device. For example, if the video content package includes the basement layer encrypted using the random encryption key, the first enhancement layer encrypted using the first chain encryption key, and the second enhancement layer encrypted using the second chain encryption key, then the random encryption key is transmitted to the second device, the first chain encryption key is transmitted to the second device when the user of the second device wants to view video content having the high resolution, and the second chain encryption key is transmitted to the second device when the user of the second device wants to view video content having the ultra high resolution.

As described above, in this embodiment, only one encryption key is transmitted to the second device not only when the user of the second device wants to view video content having the high resolution but also when the user of the second device wants to video content having the ultra high resolution. Thus, it is possible to reduce the total number of encryption keys to be managed by the second device and to reduce a storage space of the second device, which is needed to store the encryption keys. In this case, an encryption key transmitted to the second device is used as a decryption key as described above.

In another exemplary embodiment, a resolution of video content that the user of the second device wants to view may be determined by the type of the second device. For example, if the second device is a portable device, the user of the second device may be determined to want to view video content having the normal resolution. In another exemplary embodiment, identification information of, and information regarding a resolution of video content that the user of the second device wants to view, may be transmitted to the first device.

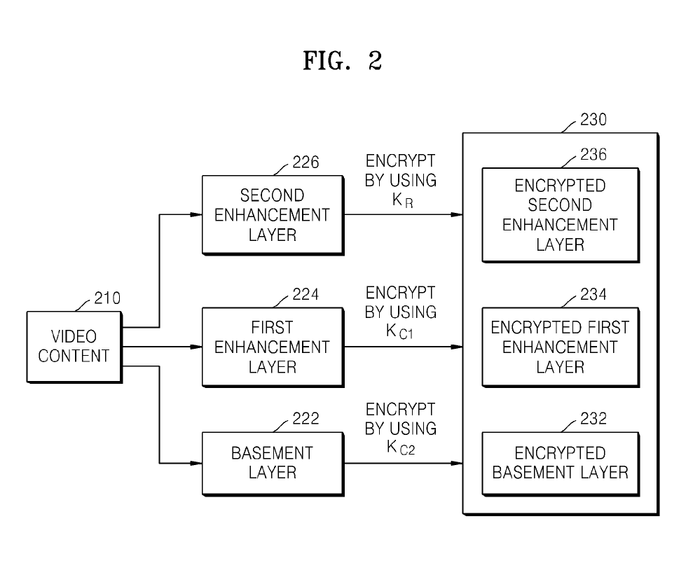

FIG. 2 is a block diagram of a method of providing SVC-based video content according to an exemplary embodiment. Referring to FIG. 2, a basement layer 222, a first enhancement layer 224, and a second enhancement layer 226 are generated by performing SVC on video content 210.

Next, the basement layer 222, the first enhancement layer 224, and the second enhancement layer 226 are encrypted using a random encryption key K_{R}, a first chain encryption key Kc1, and a second chain encryption key Kc2, respectively.

Next, a video content package 230 is generated to include the encrypted basement layer 232 and first and second enhancement layers 234 and 236.

Lastly, one of the random encryption key K_{R}, the first chain encryption key Kc1, and the second chain encryption key Kc2, and the video content package are transmitted to a second device (not shown).

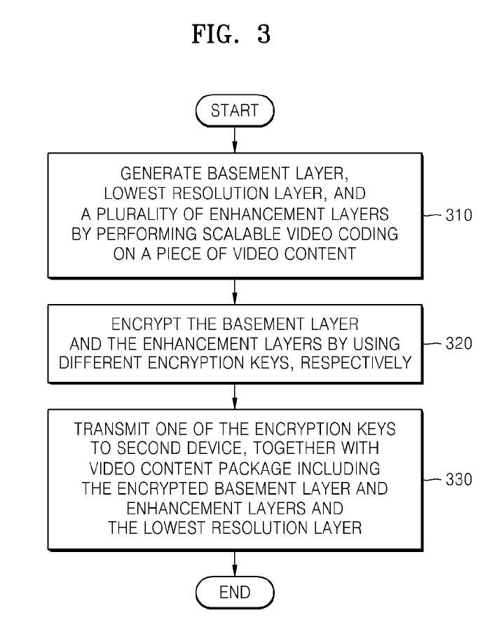

FIG. 3 is a flowchart illustrating a method of providing SVC-based video content according to anther exemplary embodiment. In operation 310, a basement layer, a lowest resolution layer having a resolution lower than that of the basement layer, and a plurality of enhancement layers are generated by performing SVC on a piece of video content.

Compared to the embodiment of FIG. 1, in the current embodiment the lowest resolution layer is further generated from a piece of video content.

In another exemplary embodiment, before operation 310 is performed, a first device may receive a request for video content having a predetermined resolution from a second device. For example, if a first device receives the request from the second device, then the basement layer, the lowest resolution layer, and the enhancement layers may be generated by performing SVC on the video content corresponding to the request, in operation 310.

In operation 320, the basement layer and the enhancement layers are encrypted using different encryption keys, respectively. In this case, the lowest resolution layer is not encrypted.

In operation 330, one of the encryption keys is transmitted to the second device, together with a video content package including the encrypted basement layer and enhancement layers and the lowest resolution layer. Compared to the embodiment of FIG. 1, the video content package further includes the lowest resolution layer that has not been encrypted.

Accordingly, if the video content package is transmitted to the second device, the second device may reproduce the video content package based on the lowest resolution layer without having to decrypt the lowest resolution layer. However, if the video content package is reproduced based on the lowest resolution layer, the resolution of the video content package is very low.

If the request is transmitted to the first device before operation 310 is performed, one of the encryption keys that corresponds to the request and the video content package are transmitted to the second device.

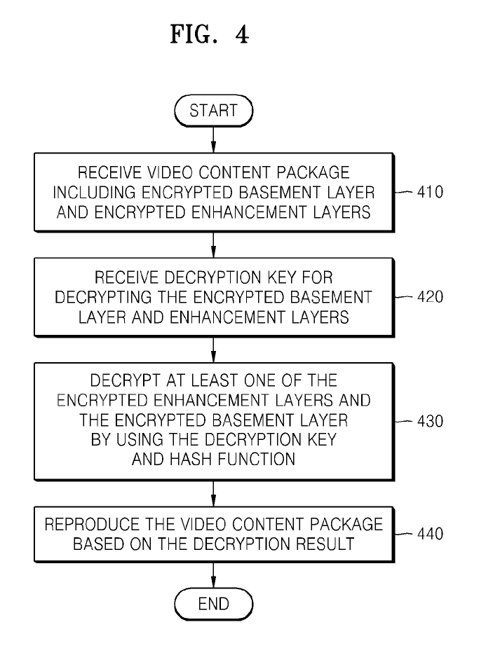

FIG. 4 is a flowchart illustrating a method of providing SVC-based video content according to anther exemplary embodiment. In operation 410, a video content package including an encrypted basement layer and a plurality of encrypted enhancement layers is received.

In another exemplary embodiment, a request for video content having a predetermined resolution may be transmitted to a device that stores the video content package before operation 410 is performed. The device that stores the video content package corresponds to a first device. It is assumed that a video reproducing device according to an exemplary embodiment is installed in a second device that receives the video content package from the first device.

For example, if the video reproducing device according to an exemplary embodiment transmits the request to the first device, then the second device may receive the video content package corresponding to the request from the first device.

In operation 420, a decryption key for decrypting the encrypted basement layer and enhancement layers included in the video content package is received.

If the request is transmitted to the first device before operation 410 is performed, a decryption key corresponding to the request is received from a content server.

In operation 430, at least one of the encrypted enhancement layers and the encrypted basement layer are decrypted using the decryption key and a Hash function.

More specifically, chain decryption keys are generated sequentially by applying the Hash function to the decryption key, and at least one of the encrypted enhancement layers and the encrypted basement layer are decrypted using at least one of the chain decryption keys and the decryption key.

For example, if a piece of video content includes a basement layer, a first enhancement layer, and a second enhancement layer, then the second enhancement layer may be decrypted using the decryption key, the first enhancement layer may be decrypted using a first chain decryption key that is generated by applying the Hash function to the decryption key, and the basement layer may be decrypted using a second chain decryption key that is generated by applying the Hash function to the first chain decryption key.

It is assumed that the first and second devices share the Hash function used to generate a chain decryption key. For example, if the first device transmits a Hash function used to generate an encryption key to the second device via a secure channel, then the first device and the video content reproducing device included in the second device may share the Hash function.

In operation 440, the video content package is reproduced based on a result of the decryption performed in operation 430.

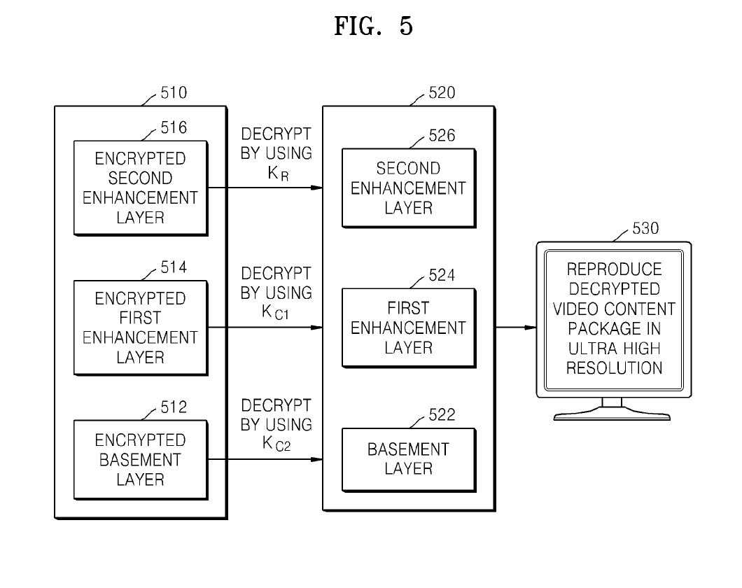

Operation 440 will be described in detail with reference to FIGS. 5 to 7.

FIGS. 5 to 7 are block diagrams of methods of providing SVC-based video content according to exemplary embodiments. In FIGS. 5 to 7, it is assumed that a video content package includes an encrypted basement layer, an encrypted first enhancement layer, and an encrypted second enhancement layer.

FIG. 5 illustrates a method of providing SVC-based video content according to another exemplary embodiment when a received decryption key is a decryption key K_{R} for decrypting an encrypted second enhancement layer 516, that is, when a user wants to view video content having an ultra high resolution.

Referring to FIG. 5, when the decryption key K_{R} and a video content package 510 are received, the encrypted second enhancement layer 516 is decrypted using the decryption key K_{R}, an encrypted first enhancement layer 514 is decrypted using a first chain decryption key Kc1 generated by applying a Hash function on the decryption key K_{R}, and an encrypted basement layer 512 is decrypted using a second chain decryption key Kc2 generated by applying the Hash function on the first chain decryption key Kc1.

A decrypted video content package 520 obtained through the above decryption process includes a second enhancement layer 526, a first enhancement layer 524, and a basement layer 522. Referring to FIG. 5, a television (TV) 530 that includes a video content reproducing device according to an exemplary embodiment reproduces the decrypted video content package 520 in an ultra high resolution, based on all the second enhancement layer 526, the first enhancement layer 524, and the basement layer 522.

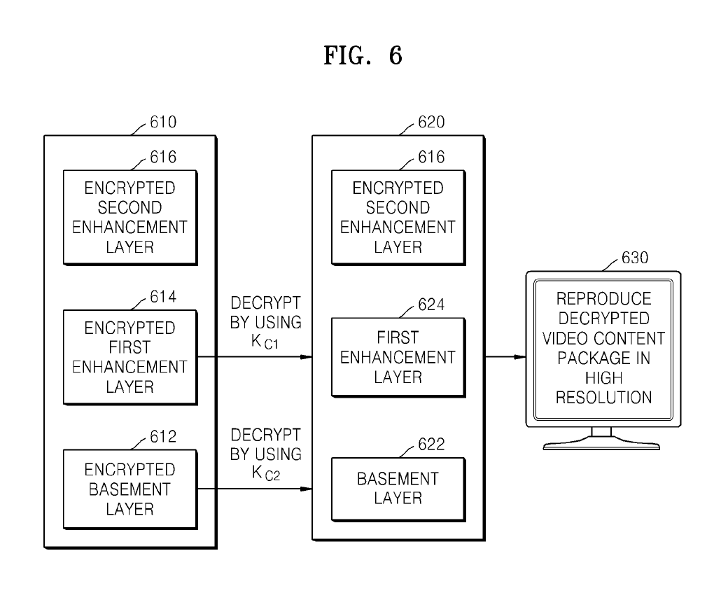

FIG. 6 illustrates a method of providing SVC-based video content according to another exemplary embodiment when a received decryption key is a decryption key Kc1 for decrypting an encrypted first enhancement layer 614, that is, when a user wants to review video content having a high resolution. Referring to FIG. 6, when the decryption key Kc1 and a video content package 610 are received, the encrypted first enhancement layer 614 is decrypted using the decryption key Kc1, and an encrypted basement layer 612 is decrypted using a first chain decryption key Kc2 generated by applying the Hash function on the decryption key Kc1. In this case, the first chain decryption key Kc2 can be generated from the decryption key Kc1, but a decryption key K_{R} for decrypting an encrypted second enhancement layer 616 cannot be generated from the decryption key Kc1, because of the uni-directionality of the Hash function. Accordingly, an encrypted second enhancement layer 616 cannot be decrypted.

A decrypted video content package 620 obtained through the above decryption process includes the encrypted second enhancement layer 616, the first enhancement layer 624, and the basement layer 622. Referring to FIG. 6, a TV 630 including a video content reproducing device according to an exemplary embodiment reproduces the decrypted video content package 620 in a high resolution, based on the first enhancement layer 624 and the basement layer 622.

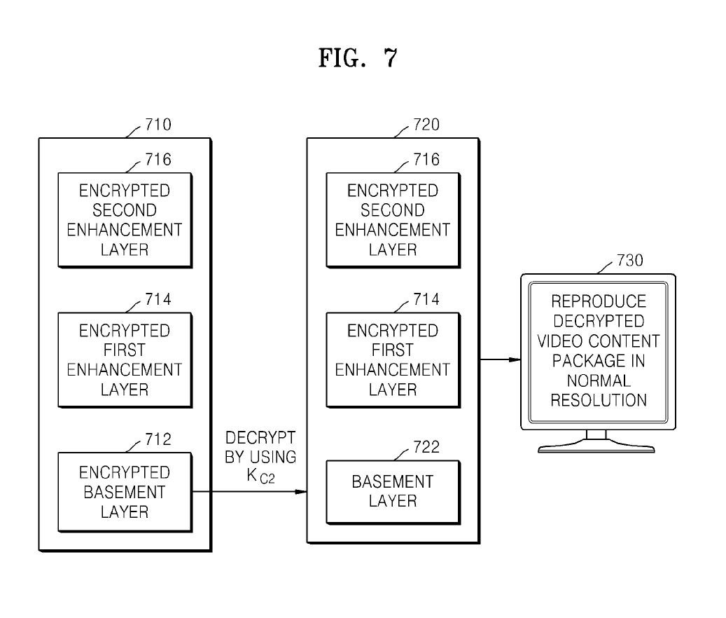

FIG. 7 illustrates a method of providing SVC-based video content according to another exemplary embodiment when a received decryption key is a decryption key Kc2 for decrypting an encrypted basement layer 712, that is, when a user wants to view video content having a normal resolution.

Referring to FIG. 7, when the decryption key Kc2 and a video content package 710 are received, the encrypted basement layer 712 is decrypted using the decryption key Kc2. In this case, decryption keys Kc1 and K_{R} for decrypting an encrypted first enhancement layer 714 and an encrypted second enhancement layer 716, respectively, cannot be generated from the decryption key Kc2 because of the uni-directionality of the Hash function. Accordingly, the encrypted first enhancement layer 714 and the encrypted second enhancement layer 716 cannot be decrypted.

A decrypted video content package 720 obtained through the above process includes the encrypted second enhancement layer 716, the encrypted first enhancement layer 714, and a basement layer 722. Referring to FIG. 7, a TV 730 including a video content reproducing device according to an exemplary embodiment reproduces the decrypted video content package 720 based on the basement layer 722.

As illustrated in FIGS. 5 to 7, according to an exemplary embodiment, a user who purchases video content having an ultra high resolution can reproduce not only the video content having the ultra high resolution but also video content having a high resolution and video content having a normal resolution and a user who purchases the video content having the high resolution may reproduce video content having the high resolution but also the video content having the normal resolution but a user who purchases the video content having the normal resolution can reproduce only the video content having the normal resolution.

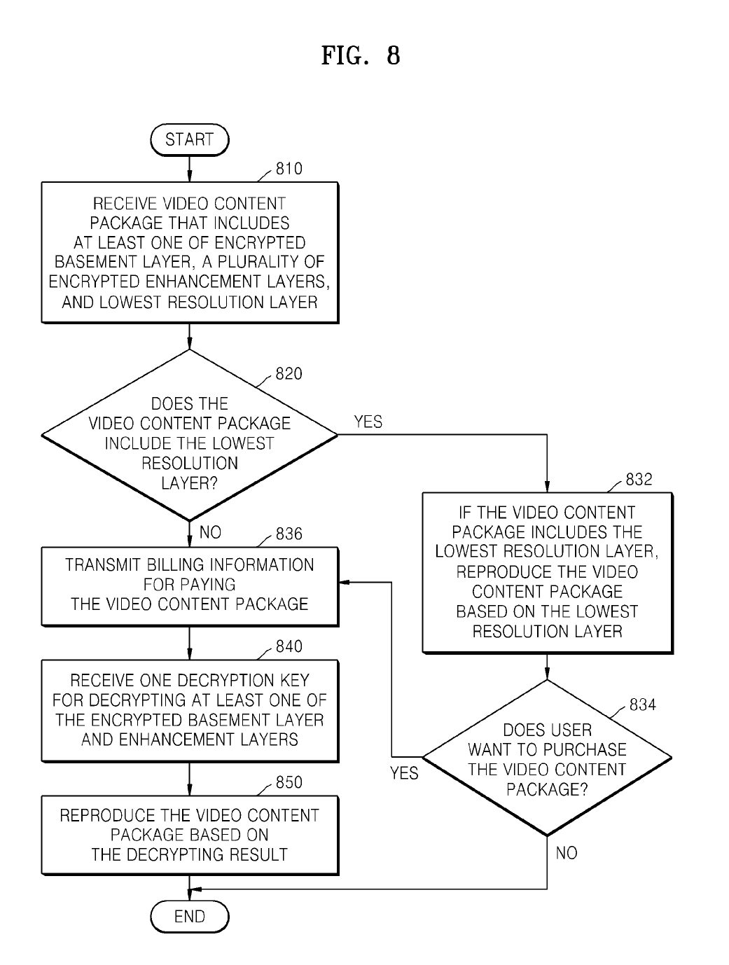

FIG. 8 is a flowchart illustrating a method of reproducing SVC-based video content according to an exemplary embodiment. In operation 810, a video content package that includes at least one selected from among an encrypted basement layer, a plurality of encrypted enhancement layers, and a lowest resolution layer having a resolution lower than that of the basement layer is received.

In another exemplary embodiment, a request for content may be transmitted to a content server that stores the video content package before operation 810 is performed.

In operation 820, it is checked whether the video content package includes the lowest resolution layer.

In operation 832, if it is determined in operation 820 that the video content package includes the lowest resolution layer, then the video content package is reproduced based on the lowest resolution layer. If the video content package is reproduced based on the lowest resolution layer, then the video content package has a very low resolution as if the video content package is expressed in a mosaic pattern. The video content package is reproduced based on the lowest resolution layer to have a very low resolution so as to arise the interest of a user who may then decide to purchase the video content package having a higher resolution after viewing the video content package in the very low resolution.

In another exemplary embodiment, if the video content package includes the lowest resolution layer, a message inquiring whether the video content package is to be reproduced based on the lowest resolution layer may pop up. Then if a command that the video content package be reproduced based on the lowest resolution layer is received from the user, the video content package may be reproduced based on the lowest resolution layer according to the command.

In operation 834, it is determined whether the user wants to purchase the video content package.

For example, if the video content package reproduced in operation 832 is a movie and the user wants to view the movie in a high resolution, then the user decides to purchase the video content package, and operation 836 is performed. However, if the user does not want to purchase the video content package after viewing the video content package reproduced based on the lowest resolution layer, then the method of FIG. 8 is discontinued.

In operation 836, if it is determined in operation 820 that the video content package does not include the lowest resolution layer or if it is determined that the user wants to purchase the video content package in operation 834, then billing information for paying for the video content package is transmitted.

If a request for content is transmitted to a content server before operation 810 is performed, the billing information may be generated based on the request. For example, if the request is for video content A having an ultra high resolution, the billing information may include an identifier of the video content A and cyber money for purchasing the video content A.

In operation 840, a decryption key for decrypting the encrypted basement layer and enhancement layers included in the video content package is received.

If a request for content is transmitted to a content server before operation 810 is performed, a decryption key corresponding to the request is received.

In operation 850, the video content package is reproduced based on a result of the decrypting.

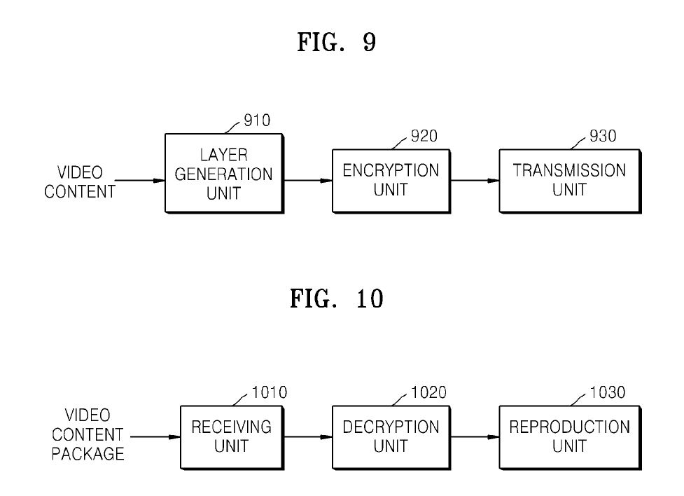

FIG. 9 is a block diagram of an apparatus for providing SVC-based video content according to an exemplary embodiment. Referring to FIG. 9, the apparatus includes a layer generation unit 910, an encryption unit 920, and a transmission unit 930. It is assumed that the apparatus according to the current embodiment is included in a first device (not shown).

The layer generation unit 910 generates one basement layer and a plurality of enhancement layers by performing SVC on a piece of video content.

The encryption unit 920 encrypts the basement layer and the enhancement layers by using different encryption keys, respectively.

More specifically, the encryption unit 920 generates a random encryption key, generates a plurality of chain encryption keys by performing a Hash function on the random encryption key at least one time, and then encrypts the basement layer and the enhancement layers by using the random encryption key and the chain encryption keys.

The transmission unit 930 transmits one of the encryption keys to a second device (not shown), together with a video content package that includes the encrypted basement layer and enhancement layers.

FIG. 10 is a block diagram of an apparatus for reproducing SVC-based video content according to an exemplary embodiment. Referring to FIG. 10, the apparatus includes a receiving unit 1010, a decryption unit 1020, and a reproduction unit 1030.

The receiving unit 1010 receives a video content package that includes an encrypted basement layer and a plurality of encrypted enhancement layers, and a decryption key for decrypting the encrypted basement layer and enhancement layers.

The decryption unit 1020 decrypts at least one of the encrypted enhancement layers and the encrypted basement layer by using the decryption key and a Hash function.

In detail, the decryption unit 1020 generates chain decryption keys sequentially by performing the Hash function on the decryption key at least one time and then decrypts at least one of the encrypted enhancement layers and the encrypted basement layer by using at least one of the chain decryption keys and the decryption key.

The reproduction unit 1030 reproduces the video content package based on a result of the decrypting.

The above exemplary embodiments may be embodied as a computer program. The computer program may be stored in a computer readable recording medium, and executed using a general digital computer. Examples of the computer readable medium include a magnetic recording medium (a ROM, a floppy disc, a hard disc, etc.), and an optical recording medium (a CD-ROM, a DVD, etc.).

While the exemplary embodiments have been particularly shown and described with reference to exemplary embodiments thereof, it will be understood by those of ordinary skill in the art that various changes in form and details may be made therein without departing from the spirit and scope of the exemplary embodiments as defined by the following claims.

What is claimed is:

1. A method of providing scalable video coding-based video content from a first device to a second device, the method comprising:
generating a basement layer and a plurality of enhancement layers by performing scalable video coding on video content;
encrypting the basement layer and the plurality of enhancement layers using different respective encryption keys; and
transmitting one of the encryption keys to the second device, together with a video content package that comprises the encrypted basement layer and the encrypted enhancement layers,
wherein the encryption keys comprise:
a random encryption key generated randomly; and
chain encryption keys generated sequentially by performing a Hash function on the random encryption key at least one time.

2. The method of claim 1, wherein during the generating of the basement layer and the plurality of enhancement layers, a lowest resolution layer having a resolution lower than a resolution of the basement layer is generated, and
the video content package further comprises the lowest resolution layer.

3. The method of claim 1, wherein the plurality of enhancement layers comprise a first enhancement layer and a second enhancement layer, and
the encrypting of the basement layer and the encrypting of the plurality of enhancement layers comprises:
encrypting the second enhancement layer by using the random encryption key;
encrypting the first enhancement layer by using a first chain encryption key generated by applying the Hash function on the random encryption key; and
encrypting the basement layer by using a second chain encryption key generated by applying the Hash function on the first chain encryption key.

4. The method of claim 1, further comprising receiving a request for video content which has a predetermined resolution from the second device, and
wherein the transmitting of one of the encryption keys to the second device, together with the video content package, comprises transmitting one of the encryption keys, which corresponds to the request, to the second device, together with the video content package.

5. The method of claim 1, wherein the encrypting of the basement layer and the plurality of enhancement layers is performed according to a symmetric key coding scheme.

6. A method of reproducing scalable video coding-based video content, the method comprising:
receiving a video content package that comprises an encrypted basement layer and a plurality of encrypted enhancement layers;
receiving a decryption key for decrypting the encrypted basement layer and the plurality of encrypted enhancement layers in the video content package;
decrypting at least one from among the encrypted basement layer and the plurality of encrypted enhancement layers by using the received decryption key and a Hash function; and
reproducing the video content package based on a result of the decrypting.

7. The method of claim 6, wherein the decrypting of the at least one from among the encrypted basement layer and the plurality of encrypted enhancement layers comprises:
generating chain decryption keys sequentially by performing the Hash function on the received decryption key at least one time; and
decrypting at least one from among the encrypted basement layer and the plurality of encrypted enhancement layers by using at least one of the chain decryption keys and the received decryption key.

8. The method of claim 6, further comprising:
when the video content package is received, checking whether the video content package comprises a lowest resolution layer having a resolution lower than a resolution of the basement layer; and
if the video content package comprises the lowest resolution layer, reproducing the video content package based on the lowest resolution layer, and
wherein the receiving of the decryption key comprises receiving the decryption key based on a result of the reproducing.

9. The method of claim 6, wherein the plurality of encrypted enhancement layers comprise an encrypted first enhancement layer and an encrypted second enhancement layer,
the decrypting of the at least one from among the encrypted basement layer and the plurality of encrypted enhancement layers comprises:
decrypting the encrypted second enhancement layer by using the received decryption key;
decrypting the encrypted first enhancement layer by using a first chain decryption key that is generated by performing the Hash function on the received decryption key; and
decrypting the encrypted basement layer by using a second chain decryption key that is generated by performing the Hash function on the first chain decryption key.

10. The method of claim 6, further comprising transmitting a request for video content having a predetermined resolution to a device that stores the video content package, and
wherein the receiving of the decryption key comprises receiving the decryption key corresponding to the request.

11. An apparatus for providing scalable video coding-based video content from a first device to a second device, the apparatus comprising:
a layer generation unit which generates a basement layer and a plurality of enhancement layers by performing scalable video coding on video content;
an encryption unit which encrypts the basement layer and the plurality of enhancement layers by using different respective encryption keys; and
a transmission unit which transmits one of the encryption keys to the second device, together with a video content package which comprises the encrypted basement layer and the encrypted plurality of enhancement layers,
wherein the encryption keys comprise:
a random encryption key generated randomly; and
chain encryption keys generated sequentially by performing a Hash function on the random encryption key at least one time.

12. The apparatus of claim 11, wherein the layer generation unit further generates a lowest resolution layer having a resolution lower than a resolution of the basement layer, and
the video content package further comprises the lowest resolution layer.

13. The apparatus of claim 11, wherein the plurality of enhancement layers comprise a first enhancement layer and a second enhancement layer, and
the encryption unit encrypts the second enhancement layer by using the random encryption key, encrypts the first enhancement layer by using a first chain encryption key generated by applying the Hash function to the random encryption key, and encrypts the basement layer by using a second chain encryption key that is generated by applying the Hash function to the first chain encryption key.

14. The apparatus of claim 11, further comprising a receiving unit which receives a request for video content which has a predetermined resolution from the second device, and
the transmission unit which transmits one of the encryption keys, which corresponds to the request, to the second device, together with the video content package.

15. The apparatus of claim 11, wherein the encryption unit performs an encryption process according to a symmetric key coding scheme.

16. An apparatus for reproducing scalable video coding-based video content, the apparatus comprising:
a receiving unit which receives a video content package that comprises an encrypted basement layer and a plurality of encrypted enhancement layers, and a decryption key which decrypts the encrypted basement layer and the plurality of encrypted enhancement layers in the video content package;
a decryption unit which decrypts at least one from among the encrypted basement layer and the plurality of encrypted enhancement layers by using the received decryption key and a Hash function; and
a reproduction unit which reproduces the video content package based on a result of the decrypting.

17. The apparatus of claim 16, wherein the decryption unit generates chain decryption keys sequentially by performing the Hash function on the received decryption key at least one time, and decrypts at least one from among the encrypted basement layer and the plurality of encrypted enhancement layers by using at least one of the chain decryption keys and the received decryption key.

18. The apparatus of claim 16, wherein when the receiving unit receives the video content package,
the reproduction unit checks whether the received video content package comprises a lowest resolution layer having a resolution lower than a resolution of the basement layer, and reproduces the video content package based on the lowest resolution layer when the video content package comprises the lowest resolution layer, and
the receiving unit receives the decryption key based on a result of the reproducing of the video content package.

19. The apparatus of claim 16, wherein the plurality of encrypted enhancement layers comprise an encrypted first enhancement layer and an encrypted second enhancement layer,
the decrypting unit decrypts the encrypted second enhancement layer by using the received decryption key, decrypts the encrypted first enhancement layer by using a first chain decryption key which is generated by performing the Hash function on the received decryption key, and decrypts the encrypted basement layer by using a second chain decryption key that is generated by performing the Hash function on the first chain decryption key.

20. The apparatus of claim 16, further comprising a transmission unit which transmits a request for video content having a predetermined resolution to a device which stores the video content package, and
wherein the receiving unit receives a decryption key corresponding to the request.

21. A computer readable recording medium having recorded thereon a computer program for executing a method of providing scalable video coding-based video content from a first device to a second device, the method comprising:
generating a basement layer and a plurality of enhancement layers by performing scalable video coding on video content;
encrypting the basement layer and the plurality of enhancement layers using different respective encryption keys; and
transmitting one of the encryption keys to the second device, together with a video content package that comprises the encrypted basement layer and the encrypted enhancement layers,
wherein the encryption keys comprise:
a random encryption key generated randomly; and
chain encryption keys generated sequentially by performing a Hash function on the random encryption key at least one time.

22. A method of providing scalable video coding-based video content from a first device to a second device, the method comprising:
generating a basement layer and at least one enhancement layer;
encrypting the basement layer and the at least one enhancement layer using different encryption keys; and
transmitting one of the encryption keys and a video content packet that comprises the encrypted basement layer and the encrypted at least one enhancement layer to the second device.

23. The method of claim 22, wherein the encryption keys comprise a random encryption key and chain encryption keys generated sequentially by performing a Hash function on the random encryption key.
